(19) United States
(12) Patent Application Publication
(10) Pub. No.: US 2010/0171706 A1
(43) Pub. Date: Jul. 8, 2010

(54) INFORMATION PROCESSOR, USER INTERFACE CONTROL METHOD AND PROGRAM

(76) Inventor: Kengo Tsuruzono, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/733,327

(22) PCT Filed: Aug. 25, 2008
(86) PCT No.: PCT/JP2008/065611

§ 371 Date: Feb. 24, 2010

(30) Foreign Application Priority Data
Sep. 4, 2007 (JP) 2007-228845

(51) Int. Cl. G06F 3/02

(52) U.S. Cl. 345/168

(57) ABSTRACT

Information processor 100 includes display 130, input part 120 which includes four direction keys for specifying up, down, left, and right directions respectively, and controller 110 which displays a virtual board and a focus indicating a currently selected block on display 140 and which moves the focus according to a direction indicator signal supplied from input part 120. The virtual board includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set. If the focus is moved to any one of the plurality of second blocks, controller 110 executes the function which has been set in the second block that is a destination of the focus.

### BACKGROUND OF THE INVENTION

1. Field of the Invention

The present invention relates to an information processor provided with a user interface in which character input and screen display control are performed using a virtual board such as a software keyboard.

2. Description of the Related Art

A device such as a portable music player has minimum required operation keys arranged thereon and therefore does not have a keyboard dedicated to character input such as used in a personal computer. As a technique for inputting characters in such a device without a keyboard dedicated to character input, there is a technique for inputting characters using a software keyboard.

Japanese Patent Laid-Open No. 2000-339091 discloses a software keyboard device which includes an input part, a display which displays a software keyboard, and a controller which receives a signal corresponding to an input operation, and, according to the received signal, moves a focus for specifying a position on a software keyboard displayed on the display and performs processing of selection/deselection of a character. The input part includes a keyboard on which keys for moving a focus and keys for selecting a character and the like are arranged.

On some of devices such as a portable music player which have minimum required operation keys arranged thereon, only four direction keys for specifying up, down, left, and right directions respectively are arranged. Since the software keyboard device described in Japanese Patent Laid-Open No. 2000-339091 requires a key for selecting a character in addition to direction keys for moving a focus, it is difficult to apply this software keyboard device to a device in which operation keys are composed of only four direction keys.

As a technique for inputting a character using a software keyboard in a device in which operation keys are composed of only four direction keys, it is conceivable that two directions keys for specifying up and down directions or left and right directions are used as operation keys for moving a focus, and functions of selection/deselection (or determination/cancel) of characters are assigned to the remaining two direction keys. However, in this case, the movement of a focus is a one-dimensional movement in the up and down directions or left and right directions, usability is poor compared to a case where a two-dimensional movement of a focus is allowed in the up, down, left, and right directions.

In addition, in the one-dimensional focus movement, numerous keystrokes as well as a long time are required to select a button on a software keyboard compared to the two-dimensional focus movement.

If functions of selection/deselection (or determination/cancel) of a character and the like are assigned to input operations such as pressing a plurality of keys simultaneously or pressing a key for a long time, four direction keys can all be used as operation keys for moving a focus. However, in this case, the user needs to precisely grasp relationships between input operations and functions. Thus, it is burdensome for the user to precisely grasp relationships between input operations and functions.

### SUMMARY OF THE INVENTION

An exemplary object of the present invention is to provide an information processor, a user interface control method and a program therefor by which a user interface using a virtual board which allows two-dimensional focus movement is implemented in which functions of selection/deselection (or determination/cancel) of a character and the like are not required to be assigned to direction keys.

An information processor according to an exemplary aspect of the present invention includes:

a display;

an input part which includes four direction keys for specifying up, down, left, and right directions respectively on a screen displayed on the display and which, when one of the direction keys is pressed, outputs a direction indicator signal which indicates a direction specified by the pressed direction key; and

a controller which displays, on the display, a virtual board including a plurality of blocks and a focus indicating a currently selected block on the virtual board and which moves the focus according to the direction indicator signal supplied from the input part,

wherein the virtual board includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set, and

wherein if the focus is moved to any one of the plurality of second blocks, the controller executes the function which has been set in the second block that is a destination of the focus, and then moves the focus to a predetermined block among the plurality of first blocks.

A user interface control method according to an exemplary aspect of the present invention, which is performed by an information processor which includes an input part which includes four direction keys for specifying up, down, left, and right directions respectively on a display screen, includes:

displaying, on a display, a virtual board which includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set;

displaying, on the display, a focus that indicates a currently selected block on the virtual board;

when any one of the four direction keys is pressed, moving the focus on the virtual board in a direction corresponding to the pressed direction key;

if the focus is moved to any one of the plurality of second blocks, executing the function which has been set in the second block that is a destination of the focus; and

moving the focus to a predetermined block among the plurality of first blocks.

A program according to an exemplary aspect of the present invention is a program which is used in an information processor which includes an input part which includes four direction keys for specifying up, down, left, and right directions respectively on a display screen, the program causing a computer to execute:

processing for displaying, on a display, a virtual board which includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set;

processing for displaying, on the display, a focus that indicates a currently selected block on the virtual board;

processing for, when any one of the four direction keys is pressed, moving the focus on the virtual board in a direction corresponding to the pressed direction key;

processing for, if the focus is moved to any one of the plurality of second blocks, executing the function which has been set in the second block that is a destination of the focus; and

processing for moving the focus to a predetermined block among the plurality of first blocks.

The above and other purposes, features, and advantages of the present invention will become apparent from the following description with reference to the accompanying drawings which illustrate examples of the present invention.

### BRIEF DESCRIPTION OF THE DRAWINGS

FIG. 1 is a block diagram which shows a configuration of an information processor as an exemplary embodiment;

FIG. 2 is a schematic diagram which shows an arrangement of a display and an input part in the information processor shown in FIG. 1;

FIG. 3 is a schematic diagram which shows a software keyboard as one example of a virtual board;

FIG. 4 is a flowchart which shows one processing procedure for moving a focus and selecting a character in the software keyboard shown in FIG. 3;

FIG. 5 is a schematic diagram which illustrates movement of a focus on the software keyboard shown in FIG. 3; and

FIG. 6 is a schematic diagram which shows another example of the virtual board.

### DETAILED DESCRIPTION OF THE EXEMPLARY EMBODIMENT(S)

Hereinafter, an exemplary embodiment of the present invention will be described with reference to the drawings.

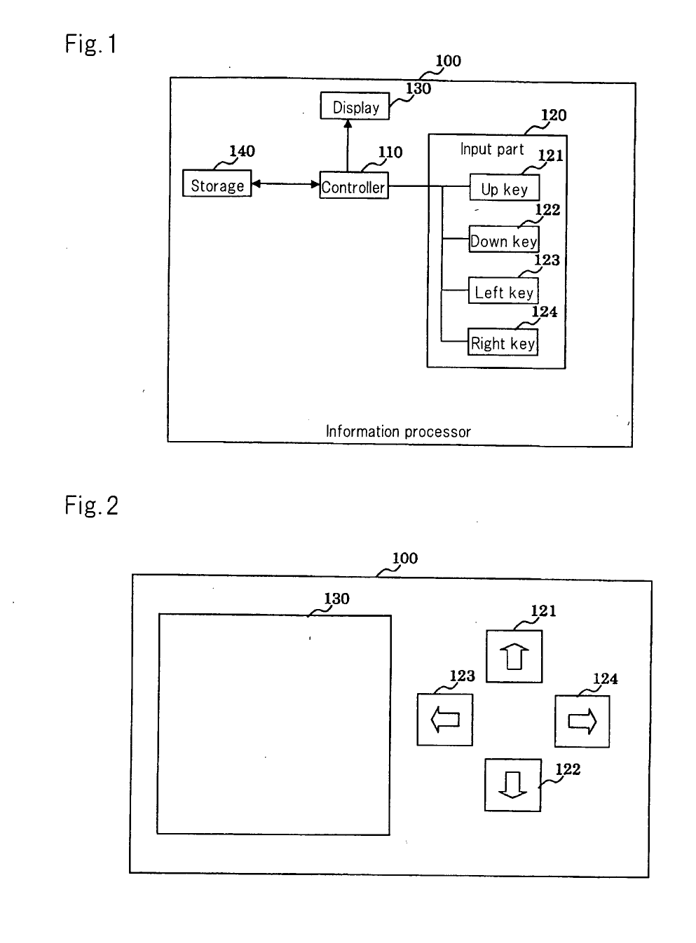

FIG. 1 is a block diagram which shows a configuration of an information processor as an exemplary embodiment of the present invention. Referring to FIG. 1, information processor 100 is a terminal such as a portable music player, and the main part thereof includes controller (CPU: Central Processing Unit) 110, input part 120, display 130, and storage 140.

Display 130 includes a display device such as a liquid crystal display or a plasma display. Storage 140 is a storage device such as a semiconductor memory or a hard disk, and stores various programs and data which are required to operate information processor 100. A program and data about a virtual board such as a software keyboard is also stored in storage 140.

Input part 120 includes up key 121, down key 122, left key 123, and right key 124 as direction keys which indicate up, down, left, and right directions respectively on a display screen of display 130. When any one of the direction keys is pressed, input part 120 supplies a direction indicator signal indicating a direction specified by the pressed direction key to controller 110.

Controller 110 executes various processing according to the program stored in storage 140. For example, controller 110 performs processing to display a virtual board and data on display 130 based on the program and data stored in storage 140, processing for moving a focus or a cursor and for selecting and inputting a character on a display screen according to the direction indicator signal supplied from input part 120, and the like. The focus indicates an area currently selected on a virtual board, and the cursor indicates a position currently selected on a character input screen (or a screen for displaying text data).

FIG. 2 schematically shows an arrangement of the display and the input part in the information processor shown in FIG. 1. Up key 121, down key 122, left key 123, and right key 124 are arranged in proximity to the screen of display 130. These direction keys are arranged so as to correspond to the up, down, left, and right directions respectively on the display screen. Thus, the direction keys are arranged such that corresponding up, down, left, and right directions on the display screen are intuitively recognized, respectively.

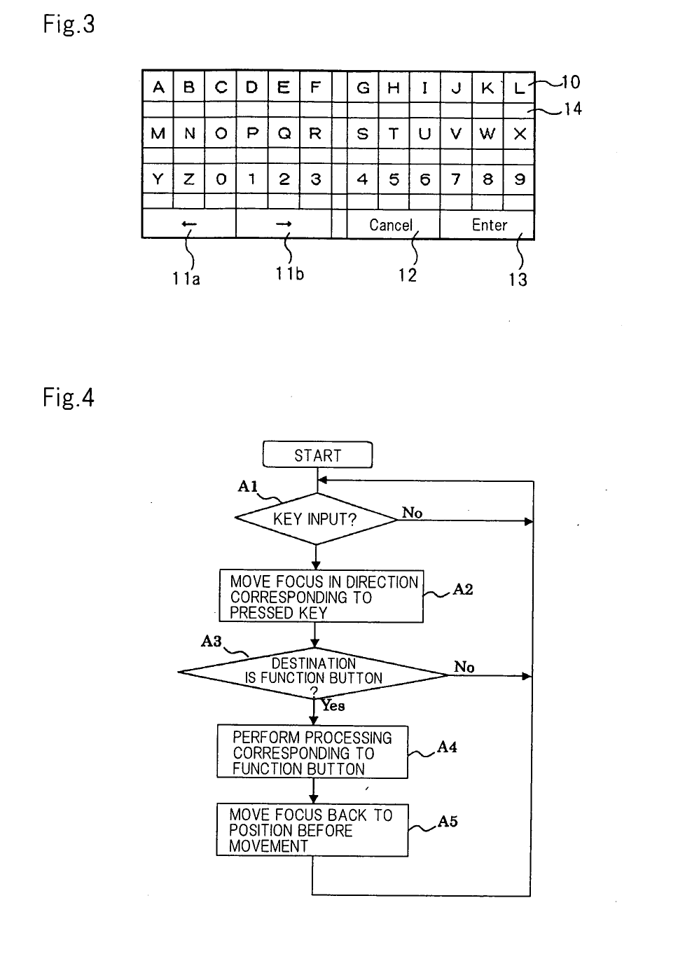

FIG. 3 schematically shows a software keyboard as one example of the virtual board. This software keyboard includes a plurality of blocks arranged in a two-dimensional array. A space area in which no function is set (a first block) or a function button in which a function is set (a second block) is assigned to each block. In the example shown in FIG. 3, character button 10, direction buttons 11a, 11b, cancel button 12, determination button 13, and space area 14 are arranged in a predetermined layout.

Character button 10 is a function button to which a function for inputting a character such as an alphabetic character or a numeric character is set. Direction buttons 11a, 11b are function buttons to which functions for specifying left and right directions on a screen respectively are set. Cancel button 12 is a function button to which a function for cancelling a selected character is set. Determination button 13 is a function button which a function for determining a selected character or character string is set. Space area 14 is an area to which no function is assigned.

Space area 14 is arranged vertically and horizontally (in the up/down direction and left/right direction). Each function button of character button 10, direction buttons 11a, 11b, cancel button 12, and determination button 13 is arranged in proximity to space area 14.

In the information processor according to the exemplary embodiment, if characters are inputted, controller 110 displays, on display 130, the software keyboard shown in FIG. 3 and a focus indicating a currently selected block on the software keyboard. Further, controller 110 displays, on display 130, a character input screen on which a character selected on the software keyboard is displayed. Then, controller 110 moves the focus on the software keyboard according to a direction indicator signal supplied from input part 120, and if its destination is a function button, controller 110 executes the corresponding function. For example, if the destination function button is character button 10, controller 100 displays a character corresponding to character button 10 on the character input screen.

FIG. 4 shows one processing procedure for moving a focus and for selecting a character in a screen of the software keyboard.

When any one of the direction keys: up key 121, down key 122, left key 123, and right key 124 is pressed (step A1, Yes), input part 120 supplies a direction indicator signal indicating a direction specified by the pressed direction key to controller 110. Controller 110 moves a focus according to the direction indicator signal supplied from input part 120 (step A2). For example, if up key 121 is pressed, controller 110 moves the focus to a block that is one block higher than a current block.

After the focus is moved, controller 110 determines whether the destination of the focus is a function button or not (step A3). If the destination of the focus is a function button, controller 110 executes a function which has been set in the function button (step A4). For example, if the destination of the focus is a character button that has been assigned character “A”, controller 110 displays “A” on the character input screen. After executing the function set in the function button, controller 110 moves the focus back to a predetermined position (in this case, the position before the movement) (step A5). Then, the process returns to step A1.

If the destination of the focus is not a function button in the determination of step A3, in other words, if the destination of the focus is space area 14, the process returns to step A1.

According to the above described procedure, each time a direction key is pressed, the focus on the software keyboard is moved in a direction corresponding to the pressed direction key. If the destination of the focus is a character button, controller 110 displays a character set in the destination character button on the character input screen. If the destination of the focus is a determination button, controller 110 determines a character or character string displayed on the character input screen as an input character. If the destination of the focus is a cancel button, controller 110 deletes a character or character string displayed on the character input screen. In this way, a user can perform an input operation using a direction key so as to move a focus to a desired block (function button) to select a desired character, determine a selected character or character string as an input character, or delete a selected character or character string.

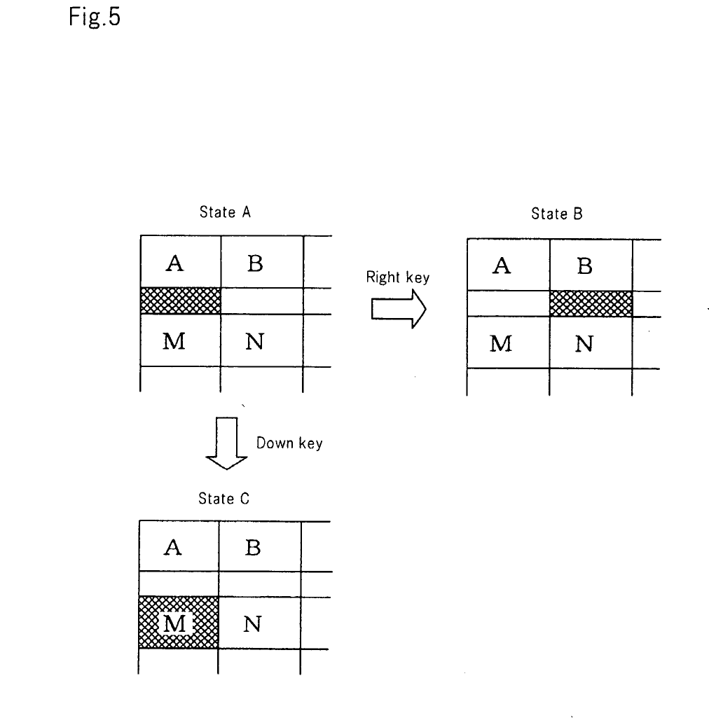

FIG. 5 schematically illustrates movement of a focus on the software keyboard shown in FIG. 3. In FIG. 5, a focus is shown as a shaded box.

In state A, a focus is positioned in a space area between character button “A” and character button “M”. In state A, if the right key is pressed so that the focus is moved to the right, the state is changed to state B in FIG. 5. In state B, the focus is positioned on a space area between character button “B” and character button “N”. Since the destination of the focus is a space area in the transition from state A to state B, the determination in step A3 of FIG. 4 is “No”.

If the down key is pressed so that the focus is moved downward in state A, the state is changed to state C in FIG. 5. In state C, the focus is positioned on character button “M”. Since the destination of the focus is a function button in the transition from state A to state C, the determination in step A3 of FIG. 4 is “Yes”. In this case, controller 110 displays “M” on the character input screen, and then moves the focus back to the position before the movement (the position of the focus in state A). Alternatively, the position to which the focus is moved back after the function is executed may be a predetermined position on the software keyboard. Alternatively, the focus may not be moved back after the function is executed, and in this case, the number of keystrokes is increased by one.

Next, the determination process at step A3 and the function execution process at step A4 which are carried out by controller 110 will be specifically described.

The storage 140 includes a frame memory in which display data (screen data) of each block of the software keyboard is stored, and a table in which information of each block is stored. In the table, with respect to each block, function setting information which indicates the presence or absence of a function setting is stored in association with position information (address) of the block on the frame memory. Further, in the table, function execution information which indicates details of a function to be executed is stored with respect to a block in which a function is set.

Controller 110 manages a display position of a focus by associating it with position information of blocks on the frame memory. Controller 110 recognizes a block corresponding to a current focus position based on the display position of the focus and the position information of blocks on the frame memory, and acquires function setting information with respect to the recognized block from the table. Then, controller 110 determines whether a block that is the destination of the focus is a function block or not based on the acquired function setting information.

On the other hand, if the destination of the focus is a function block, controller 110 acquires function execution information with respect to the function block from the table. Then, controller 110 executes the function set in the function block based on the acquired function execution information.

According to the information processor of the above described exemplary embodiment, a focus can be moved to directions (up, down, left, and right) specified by the four direction keys respectively. Since two-dimensional focus movement using the four direction keys is allowed as described above, there is an advantage that usability is improved compared to a case where one-dimensional focus movement is performed.

In addition, generally, the number of keystrokes for selecting any button on a virtual board is less in a two-dimensional focus movement than in one-dimensional focus movement. According to the information processor of the exemplary embodiment, since a two-dimensional focus movement is allowed, the number of keystrokes for selecting a button on a virtual board can be reduced compared to in a one-dimensional focus movement, and the time required to select the button can be correspondingly reduced.

Further, as shown in FIG. 2, four directions keys are provided in positions corresponding to the up, down, left, and right directions respectively on an area in proximity to the screen of the display, so that an intuitive operation is enabled.

In addition, according to the information processor of the exemplary embodiment, when a focus is moved onto a function button, the function which has been set in the function button is executed. Therefore, a special input operation (for example, simultaneous pressing of a plurality of keys) for executing a function is not required, and functions of selection/deselection (or determination/cancel) of a character and the like are not required to be assigned to direction keys. Thereby, the number of keystrokes can be further reduced.

The above described exemplary embodiment is one example of the present invention, and the configuration and operation thereof may be changed as necessary without departing from the spirit of the invention.

For example, the virtual board is not limited to the software keyboard shown in FIG. 3. The virtual board may have any form in which space areas are arranged contiguously in a direction (the up/down direction or the left/right direction or the up/down and left/right directions) which can be specified by a direction key, and function buttons are arranged in proximity to these space areas.

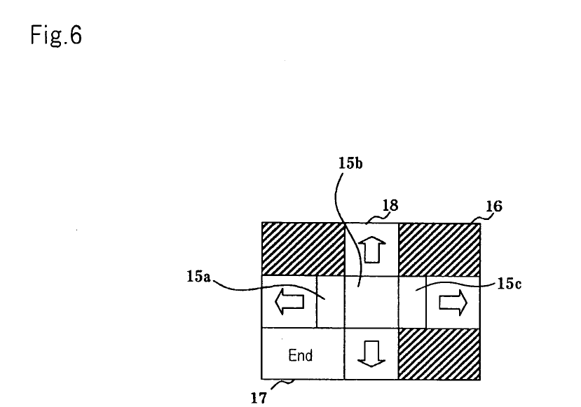

FIG. 6 shows another example of the virtual board. Referring to FIG. 6, three space areas 15a to 15c are arranged in one direction, and end button 17 and four direction buttons 18 which indicate up, down, right, and left directions respectively are arranged in proximity to these space areas 15a to 15c. Shaded area 16 is an area to which a focus cannot be moved. End button 17 and direction buttons 18 are function buttons. Using this virtual board allows for example, scrolling in the up/down direction or right/left direction on the display screen of display 130. The scrolling operation will be briefly described below.

Data (such as image, text, and graphics) to be subjected to the scrolling process is stored in storage 140. Controller 110 displays a screen of data to be subjected to the scrolling process together with the virtual board shown in FIG. 6, on display 130.

In a case where a focus on the virtual board is in a space area between a direction button indicating upward direction and a direction button indicating downward direction, when up key 121 is pressed once, controller 110 moves the focus onto the direction button indicating upward direction. Because the destination of the focus is a function button in this instance, controller 110 performs processing that corresponds to the function button, that is, processing to scroll the screen of the displayed data by a certain amount thereof in the upward direction. After performing the scrolling process, controller 110 moves the focus back to the position before the movement.

In a case where the focus is positioned in the central space area, when left key 123 is pressed twice, scrolling to the left is performed, and when right key 124 is pressed twice, scrolling to the right is performed. In this way, screen scrolling can be performed by input operation using four keys 121 to 124 of input part 120.

In a case where the focus is positioned in the central space area, if left key 123 is pressed once and then down key 122 is pressed once, the focus is moved to end button 17. In this case, controller 110 terminates the scrolling process with the virtual board.

According to the above described scrolling processing with the virtual board, the two-dimensional focus movement using four direction keys, and the two-dimensional scrolling operation using four scroll buttons corresponding to the up, down, left, and right directions respectively are allowed, so that operation for scrolling a displayed document in four directions, up, down, left, and right, can be performed intuitively.

In the above described information processor 100, a menu selection screen may be displayed on display 130 on start-up, in which as menu items, there are provided an item which indicates the process for inputting character using the software keyboard as shown in FIG. 3, an item which indicates the screen scrolling process using the virtual board as shown in FIG. 6, and the like. This menu selection screen is also formed on a virtual board.

On the virtual board for the menu selection screen, space areas are arranged, and buttons corresponding to the respective processing items and function buttons such as a determination button and a cancel button are arranged in proximity to the space areas. By an input operation using relevant keys of input part 120, a focus is moved on the menu selection screen and the required item is selected. After the selection of the item, if the focus is moved onto the determination button, processing corresponding to the selected item is performed. The focus is moved onto the cancel button in a case where the selected item is to be changed. Processing to move the focus and the process that corresponds to a destination function button are controlled by controller 110.

The present invention can be applied to electronic equipment, such as a portable music player, which includes, as operation keys, four direction for specifying up, down, left, and right directions respectively.

According to one exemplary aspect of the present invention, an information processor includes: a display; an input part which includes four direction keys for specifying up, down, left, and right directions respectively on a screen displayed on the display and, when any one of the direction keys is pressed, outputs a direction indicator signal which indicates a direction specified by the pressed direction key; and a controller which displays a virtual board including a plurality of blocks and a focus indicating a currently selected block on the virtual board, on the display, and moves the focus according to the direction indicator signal supplied from the input part. The virtual board includes a plurality of first blocks which are arranged contiguously along the up/down direction or the left/right direction or the up/down and left/right directions and in which no function has been set and a plurality of second blocks which are arranged in proximity to the first blocks and in which a function has been previously set. If the function has been set in a block that is the destination of the focus, the controller executes the function and moves the focus to a predetermined block among the plurality of first blocks.

According to the above described invention, a focus can be moved to directions (up, down, left, and right directions) specified by the four direction keys respectively. Since a two-dimensional focus movement using the four direction keys is allowed as described above, there is an advantage that usability is improved compared to a case where a one-dimensional focus movement is performed.

In addition, generally, the number of keystrokes for selecting any button on a virtual board is less in a two-dimensional focus movement than in a one-dimensional focus movement. According to the present invention, since a two-dimensional focus movement is allowed, the number of keystrokes for selecting a button on a virtual board can be reduced compared to in a one-dimensional focus movement, and the time required to select the button can be correspondingly reduced.

Further, according to the described above present invention, when a focus is moved onto a block in which a function has been set, the function set in the block is automatically executed. Therefore, a special input operation (for example, simultaneous pressing of a plurality of keys) for executing a function is not required, and functions of selection/deselection (or determination/cancel) of a character and the like are not required to be assigned to direction keys.

This application is based upon and claims the benefit of priority from Japanese Patent Application No. 2007-228845 filed in Japan Patent Office on Sep. 4, 2007, the contents of which are hereby incorporated by reference.

While exemplary embodiments of the present invention have been described using specific terms, such description is for illustrates purposes only, and it is to be understood that changes and variations may be made without departing from the spirit or scope of the following claims.

1. An information processor comprising:
a display;
an input part which includes four direction keys for specifying up, down, left, and right directions respectively on a screen displayed on the display and which, when any one of the direction keys is pressed, outputs a direction indicator signal that indicates a direction specified by the pressed direction key; and
a controller which displays, on the display, a virtual board including a plurality of blocks and a focus indicating a currently selected block on the virtual board and which moves the focus according to the direction indicator signal supplied from the input part,
wherein the virtual board includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set, and
wherein if the focus is moved to any one of the plurality of second blocks, the controller executes the function which has been set in the second block that is a destination of the focus, and then moves the focus to a predetermined block among the plurality of first blocks.

2. The information processor according to claim 1, wherein the plurality of second blocks includes a plurality of character buttons to which a function for inputting a character has been set, a determination button to which a function for determining an input character has been set, and a cancel button to which a function for cancelling an input character has been set, and
wherein the controller displays a character input screen and the virtual board on the display,
wherein if the focus is moved to any one of the plurality of character buttons, the controller displays a character, which has been set in the character button that is the destination of the focus, on the character input screen; if the focus is moved to the determination button, the controller determines a character or character string, which has been displayed on the character input screen, as an input character, and if the focus is moved to the cancel button, the controller deletes a character or character string which has been displayed on the character input screen.

3. The information processor according to claim 1, wherein the plurality of second blocks includes four scroll buttons to which functions for scrolling the screen, which is displayed on the display in up, down, left, and right directions, has been set respectively, and an end button to which a function for terminating scrolling process has been set, and
wherein the controller displays, on the display, a screen of given data, which is to be subjected to the scrolling process, and the virtual board,
wherein if the focus is moved to any one of the four scroll buttons, the controller scrolls the screen displaying the data in a direction which has been set in the scroll button that is the destination of the focus, and if the focus is moved to the end button, the controller terminates the scrolling process in which the virtual board is employed.

4. The information processor according to claim 1, wherein the four direction keys are provided in positions corresponding to the up, down, left, and right directions respectively on an area in proximity to the screen of the display.

5. A user interface control method which is performed by an information processor which includes an input part which includes four direction keys for specifying up, down, left, and right directions respectively on a display screen, the method comprising:
displaying, on a display, a virtual board which includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set;
displaying, on the display, a focus that indicates a currently selected block on the virtual board;
when any one of the four direction keys is pressed, moving the focus on the virtual board in a direction corresponding to the pressed direction key;
if the focus is moved to any one of the plurality of second blocks, executing the function which has been set in the second block that is a destination of the focus; and
moving the focus to a predetermined block among the plurality of first blocks.

6. A recording medium recorded with a program which is used in an information processor which includes an input part which includes four direction keys for specifying up, down, left, and right directions respectively on a display screen, the program causing a computer to execute:
processing for displaying, on a display, a virtual board which includes a plurality of first blocks, which are arranged contiguously along the up/down direction or the left/right direction or the up/down and left/right directions and to which no function has been set, and a plurality of second blocks which are arranged in proximity to the first blocks and to which a function has been previously set;
processing for displaying, on the display, a focus that indicates a currently selected block on the virtual board;
processing for, when any one of the four direction keys is pressed, moving the focus on the virtual board in a direction corresponding to the pressed direction key;
processing for, if the focus is moved to any one of the plurality of second blocks, executing the function which has been set in the second block that is a destination of the focus; and
processing for moving the focus to a predetermined block among the plurality of first blocks.
